(19) United States
(12) Patent Application Publication
(10) Pub. No.: US 2018/0282239 A1
(43) Pub. Date: Oct. 4, 2018

(54) AQUEOUS SUSPENSION COMPOSITIONS CONTAINING N-(N-BUTYL) THIOPHOSPHORIC TRIAMIDE AND DICYANDIAMIDE

(71) Applicant: Koch Agronomic Services, LLC, Wichita, KS (US)

(72) Inventor: Drew R. Bobeck, Decatur, GA (US)

(73) Assignee: Koch Agronomic Services, LLC, Wichita, KS (US)

(21) Appl. No.: 15/940,496

(22) Filed: Mar. 29, 2018

Related U.S. Application Data
(60) Provisional application No. 62/480,664, filed on Apr. 3, 2017.

(51) Int. Cl. C05G 3/00; C05G 3/02; C05C 9/00; C05G 3/08

(52) U.S. Cl. CPC C05G 3/0076; C05G 3/08; C05C 9/00; C05G 3/02

(57) ABSTRACT

The present subject matter relates generally to stable and homogeneous aqueous suspension compositions comprising urea, water, a suspension agent, urease inhibitor N-(n-butyl) thiophosphoric triamide (NBPT) and nitrification inhibitor dicyandiamide (DCD), and to methods of preparing and using such compositions.

### CROSS REFERENCE TO RELATED APPLICATIONS

This present application claims priority to U.S. Provisional Patent Application No. 62/480,664 filed Apr. 3, 2017 the disclosures of which are incorporated by reference herein.

### FIELD OF THE DISCLOSURE

The present subject matter relates to stable and homogeneous aqueous suspension compositions comprising urea, water, a suspension agent, urease inhibitor N-(n-butyl) thiophosphoric triamide (NBPT) and nitrification inhibitor dicyandiamide (DCD), and to methods of preparing and using such compositions.

### BACKGROUND

Fertilizers have been used for some time to provide nitrogen to the soil. The most widely used and agriculturally important nitrogen fertilizer is urea, CO(NH₂)₂. Most of the urea currently produced is used as a fertilizer in its granular (or prilled) form. After application of urea to soil, it is readily hydrolyzed to yield ammonia and carbon dioxide. This process is catalyzed by the enzyme urease, which is produced by some bacteria and fungi that may be present in the soil. The gaseous products formed by the hydrolysis reaction (i.e., ammonia and carbon dioxide) can volatilize to the atmosphere and thus, substantial losses from the total amount of the nitrogen applied to the soil can occur.

Attempts to reduce losses of applied nitrogen have utilized urease inhibitors and/or nitrification inhibitors as additives to the fertilizer. Urease inhibitors are compounds capable of inhibiting the catalytic activity of the urease enzyme on urea in the soil. Nitrification inhibitors are compounds capable of inhibiting the bacterial oxidation of ammonium to nitrate in the soil. Urease inhibitors and nitrification inhibitors can be associated with fertilizers in various ways. For example, they can be coated onto fertilizer granules or mixed into fertilizer matrices. A number of granulation methods are known, including falling curtain, spherudization-agglomeration drum granulation, prilling and fluid bed granulation technologies.

Examples of urease inhibitors are the thiophosphoric triamide compounds disclosed in U.S. Pat. No. 4,530,714 to Kolc et al. The disclosed thiophosphoric triamide compounds include N-(n-butyl) thiophosphoric triamide (NBPT), the most developed representative of this class of compounds. When incorporated into a urea-containing fertilizer, NBPT reduces the rate at which urea is hydrolyzed in the soil to ammonia. The benefits realized as a result of the delayed urea hydrolysis include the following: (1) nutrient nitrogen is available to the plant over a longer period of time; (2) excessive build-up of ammonia in the soil following the application of the urea-containing fertilizer is avoided; (3) the potential for nitrogen loss through ammonia volatilization is reduced; (4) the potential for damage by high levels of ammonia to seedlings and young plants is reduced; (5) plant uptake of nitrogen is increased; and (6) an increase in crop yields is attained. NBPT is commercially available for use in agriculture and is marketed in such products as the AGROTAIN® nitrogen stabilizer product line.

Examples of nitrification inhibitors are dicyandiamide (DCD) and 2-chloro-6-(trichloromethyl)-pyridine (Nitrapyrin).

U.S. Pat. No. 9,394,210 to Gabrielson disclosed an improved homogenous granular fertilizer composition that is comprised primarily of urea, NBPT and DCD. The process of making fertilizer embodied in Gabrielson mentions in one embodiment that DCD and NBPT are separately introduced into a molten urea at different stage of the process. Further, Gabrielson suggests that DCD can be introduced as a solid and NBPT is introduced as a concentrated solution in a liquid amide such as N-methyl-2-pyrrolidone (NMP).

It is well known that both DCD and NBPT can be difficult materials to handle, which adds to the cost of making an incorporated fertilizer.

DCD has limited solubility in common solvents, and thus limits the choice of solvents available for these common solvent-containing applications. Polar solvents such as dimethylformamide (DMF), dimethylsulfoxide (DMSO) and N-methylpyrodinone (NMP), are commonly used with dicyandiamide. Unfortunately, such solvents have high boiling points, which makes it difficult to remove the solvent.

Similarly, industrial grade NBPT is a waxy, sticky, heat-sensitive and water-sensitive material (see also WO 2010/045895 and U.S. Pat. No. 8,513,460). Because of the solubility issues of industrial grade NBPT and the temperatures involved in the injecting NBPT into molten urea (i.e. 275° F.), NMP has always been used as a co-solvent in the direct incorporation of NBPT into molten urea (see Gabrielson). While this solvent is ideal for incorporation process into molten urea because of its high boiling point and polarity, it is also difficult to remove from the final products, especially on the large scales required for efficient production of fertilizer compositions. Therefore, the ability to use less NMP is desirable.

The separate introduction of NBPT in a concentrated NMP solution and DCD in dry form as disclosed in Weston not only adds the cost for the process, requires the organic solvent, and may also raise safety concerns. Therefore, there is a need for improved method of making an incorporated urea granular comprising NBPT and DCD.

### SUMMARY OF THE DISCLOSURE

One of the primary objectives of the present disclosure is to provide stable and homogeneous aqueous suspension compositions comprising NBPT and DCD for a more economic and safe process to make incorporated urea fertilizer comprising NBPT and DCD.

The current industrial processes for making incorporated urea with NBPT and DCD are by introducing NBPT in polar organic solvent, and introducing DCD in polar organic solvent or in dry form to a molten urea. The current industrial processes not only make it difficult to remove the high boiling point solvent from the final fertilizer product, but also introduces a safety risk due to the use of such organic solvents. Therefore, there is a long-felt-need to develop more economic and safer compositions and/or processes in preparing incorporated urea with NBPT and DCD.

The present disclosure provides surprisingly stable homogeneous aqueous suspension compositions of NBPT and DCD. Because of the unexpected stability and homogeneity, and lack of the using of organic solvent, it makes the preparation, storage, transportation and usage of the suspension composition much easier, safer, and more economic.

In one embodiment, the present disclosure provides stable and homogeneous aqueous suspension composition comprising urea, water, a suspension agent, N-(n-butyl) thiophosphoric triamide (NBPT), dicyandiamide (DCD), and an optional dye.

In another embodiment, the present disclosure provides a method to make an incorporated urea-containing fertilizer composition by introducing a stable homogeneous aqueous suspension composition into a molten urea, wherein stable homogeneous aqueous suspension composition comprising urea, water, a suspension agent, N-(n-butyl) thiophosphoric triamide (NBPT), dicyandiamide (DCD), and an optional dye.

### DETAILED DESCRIPTION OF THE DISCLOSURE

As disclosed herein, stable and homogeneous aqueous suspension compositions comprising urea, water, a suspension agent, N-(n-butyl) thiophosphoric triamide (NBPT), dicyandiamide (DCD), an optional dye, and methods of preparing and using such compositions are provided.

Unless defined otherwise, all technical and scientific terms used herein have the same meaning as commonly understood by those of ordinary skill in the art.

The term “suspension” in present disclosure means a heterogeneous mixture comprising both solid particles and a liquid carrier. The term “homogeneous aqueous suspension” generally means that when dividing the volume of the whole suspension in half, the substantially same amount of materials are suspended in both halves of the suspension compositions. The term “substantially same amount” is not absolute and may include up to ±10% difference. For example, when the whole suspension is divided into two halves, a specific ingredient may have 45 percent in one half and the remaining 55% in the other half.

The term “stable” in present disclosure means both the chemical and physical stabilities. For physical stability, it means that the suspension stays substantially homogeneous for at least 14 days, including up to about 6 months, or can be easily returned to a suspension by agitation.

In the present disclosure, most of NBPT and DCD are in solid form in the suspension, however, part of NBPT and DCD may solubilize in water. The water solubility of NBPT is 4.3×10⁻³ g/mL at 25° C. The water solubility of DCD is 4.13×10⁻² g/mL. The actual solubility of NBPT and DCD in the suspension compositions of the present disclosure may vary and may not be the same as their individual water solubility.

The suspension composition can provide an extended period of stability to maintain as a substantially homogeneous suspension. Because the suspension composition comprises both NBPT and DCD, it only requires one single introduction of the suspension composition into a molten urea to make a substantially homogeneous urea fertilizer comprising both NBPT and DCD. This process is more economic and more advantageous since it avoids the use of polar and high boiling point organic solvents such as NMP to dissolve NBPT.

In one embodiment, the present disclosure provides a stable and homogeneous aqueous suspension composition comprising urea, water, a suspension agent, N-(n-butyl) thiophosphoric triamide (NBPT), dicyandiamide (DCD), and an optional dye.

In one aspect, the suspension agent in the present disclosure is selected from the group consisting of dextran, gellan, rhamsan, guar, xanthan gums, tragacanth gum, hydroxymethylcellulose, hydroxyethylcellulose, microcrystalline cellulose, polyvinyl alcohols, polyvinyl acetates and cross-linked polyacrylates. In one aspect, a preferred suspension agent is xanthan gums.

In one aspect, the optional dye in the present disclosure may be any commonly used dye including food dyes that may be used to provide visual evidence of the uniformity of the composition. Examples of dyes suitable in the present disclosure include but are not limited to FD&C Blue No. 1, FD&C Blue No. 1, FD&C Green No. 3, FD&C Yellow No. 5, FD&C Red No. 3, FD&C Red No. 40, FD&C Yellow No. 6, and AGROTAIN® ULTRA green dye, or a combination thereof.

In one aspect, the aqueous suspension composition in the present disclosure may further comprise a biocide. Examples of biocides include Proxel™ GXL biocide, Koralone™ biocide, and Bardac™ biocide.

In one aspect, the weight percentage range of NBPT in the aqueous suspension composition is 0.01% to 40% by weight, including 0.5% to 30% by weight, 1.0% to 20% by weight, and 1.0% to 10% by weight. In another aspect, the weight percentage range of NBPT is 1.0% to 10% by weight, including 1.0% to 5.0% by weight, 2.0% to 5.0% by weight, and 3.0% to 5.0% by weight. In one aspect, the weight percentage range of DCD in the aqueous suspension composition is 10% to 70% by weight, including 20% to 60% by weight, 20% to 50% by weight, and 30% to 50% by weight. In one aspect, the weight percentage range of urea in the aqueous suspension composition is 10% to 40% by weight, including 15% to 30% by weight and 20% to 25% by weight. In one aspect, the weight percentage range of a suspension agent in the aqueous suspension composition is 0.01% to 10% by weight, including 0.05% to 5% by weight, 0.10% to 3% by weight, and 0.15% to 1% by weight. In one aspect, the weight percentage range of a dye in the total aqueous suspension composition is 0.001-5% by weight, including 0.02% to 2% by weight, and 0.05% to 1% by weight.

In one aspect, 0.01% to 10% of the DCD by weight is solubilized in the aqueous suspension of the present disclosure, including 0.1% to 7.5% by weight and 1.0% to 5.0% by weight. In one aspect, 0.01% to 10% of the NBPT by weight is solubilized in the aqueous suspension of the present disclosure, including 0.1% to 7.5% by weight and 1.0% to 5.0% by weight.

In another aspect, the aqueous suspension composition can comprise 0.01% to 40% by weight of NBPT and 10% to 70% by weight of DCD, wherein 0.01% to 10% by weight of the DCD is solubilized in the aqueous suspension and 0.01% to 10% by weight of the NBPT is solubilized in the aqueous suspension. Further, the NBPT in the above aqueous suspension can by solubilized in an amount from 0.1% to 7.5% by weight. Also, the DCD in the above aqueous suspension can be solubilized in an amount from 0.1% to 7.5% by weight.

In a further aspect, the aqueous suspension composition can comprise 1.0% to 20% by weight of NBPT and 20% to 50% by weight of DCD, wherein 0.01% to 10% by weight of the DCD is solubilized in the aqueous suspension and 0.01% to 10% by weight of the NBPT is solubilized in the aqueous suspension.

### Example 1. Aqueous Suspension Composition #1

| Ingredient | Weight Percentage | g/L |
|---|---|---|
| DCD “G” Grade | 46.34% | 561.9 |
| NBPT Tech Grade | 3.35% | 40.7 |
| Powder Blue Dye | 0.09% | 1.2 |
| Xanthan Gum | 0.18% | 2.4 |
| Urea | 21.75% | 264.6 |
| Water | 28.29% | 343.8 |

### Method of Making Slurry—Basic Process

Liquid carrier (water and urea) are added to a mixing vessel and mixed, while xanthan gum is slowly added. The xanthan gum and liquid carrier mixture is sampled at various timepoints throughout the process for viscosity plateau to ensure full saturation of the xanthan gum into the liquid carrier. Once full saturation occurs, the NBPT, DCD and optional dye are added to the mixing vessel and mixing continues until the slurry is homogenous (10-15 additional minutes). Optionally, a biocide can be added to the slurry after homogeneity is reached. If added, the slurry is mixed for an additional 5 minutes.

### Example 2—Method of Making Aqueous Suspension Composition #2

Aqueous Suspension Composition #2 contains 50% DCD (AB grade), and 0.15% xanthan gum in a 20-0-0 (i.e. 20% nitrogen) urea solution slurry. The above basic process was carried out as follows: 937.98 grams of 20-0-0 urea solution was added to the mixing vessel and mixed while 2.84 grams of xanthan gum was added over the course of 1 minute. After 5 minutes of mixing, the xanthan gum+urea mixture was tested for viscosity on a DV-II+Brookfield viscometer with a #18 spindle at 20 rpm. The viscosity reading was 112.5 cP. The above step was repeated 4 additional times (total of 5), until the last three viscosity measurements read 247.8 cP, 257.4 cP, and 247 cP. It was then determined that 25 minutes was the point of saturation for the xanthan gum. 946.5 grams of the DCD were added along with 5.68 grams of dye to the mixture. After the dye addition, the mixture was mixed for 10 minutes.

### Example 3—Method of Making Aqueous Suspension Composition #3

Aqueous Suspension Composition #3 contains 43.7% DCD (AB grade), 3.30% NBPT, and 0.21% xanthan gum in a 32-0-0 (32% nitrogen) UAN slurry. The above basic process was carried out as follows: 993.25 grams of 32-0-0 UAN was added to the mixing vessel and mixed while 3.98 grams of xanthan gum was added over the course of 1 minute. After 5 minutes of mixing, the xanthan gum+urea mixture was tested for viscosity on a DV-II+Brookfield viscometer with a #31 spindle at 100 rpm. The viscosity was 254 cP. The above step was repeated 5 additional times (total of 6), until the last three viscosity measurements read 53500 cP, 57600 cP, and 57600 cP. It was then determined that 30 minutes was the point of saturation for the xanthan gum. 827.4 grams of DCD and 62.47 grams of NBPT were added along with 6.05 grams of dye to the mixture. After the dye addition, the mixture was mixed for 10 minutes.

### Example 4—Method of Making Aqueous Suspension Composition #4

Aqueous Suspension Composition #4 contains 43.7% DCD (AB grade), 3.30% NBPT, and 0.25% xanthan gum in a 32-0-0 (32% nitrogen) UAN slurry. The same procedure as Example 3 was followed, except that 0.25% xanthan gum was used. The final 3 viscosity measurements were 26410 cP, 25800 cP, and 27400 cP. It was t determined that 30 minutes was the point of saturation for the xanthan gum.

### Example 5—Method of Making Aqueous Suspension Composition #5

Aqueous Suspension Composition #5 contains 46.3% DCD (AB grade), 3.35% NBPT, and 0.18% xanthan gum in a 32-0-0 UAN slurry. The above basic process was carried out as follows: 944.04 grams of 32-0-0 UAN was added to the mixing vessel and mixed while 3.41 grams of xanthan gum was added over the course of 1 minute. After 5 minutes of mixing, the xanthan gum+urea mixture was tested for viscosity on a DV-II+Brookfield viscometer with a #18 spindle at 100 rpm. The viscosity was 890 cP. The above step was repeated 4 additional times (total of 5), until the last three viscosity measurements read 1560 cP, 1960 cP, and 1955 cP. It was then determined that 30 minutes was the point of saturation for the xanthan gum. 876.46 grams of DCD and 63.42 grams of NBPT were added along with 5.68 grams of dye to the mixture. After the dye addition, the mixture was mixed for 10 minutes.

### Example 6—Method of Making Aqueous Suspension Composition #6

Aqueous Suspension Composition #6 contains 46.89% DCD (AB grade), 3.90% NBPT, and 0.15% xanthan gum in a 32-0-0 UAN slurry with 0.10% Proxel GXL biocide. The above basic process was carried out as follows: 887.63 grams of 32-0-0 UAN was added to the mixing vessel and mixed while 2.84 grams of xanthan gum was added over the course of 1 minute. After 20 minutes of mixing, the xanthan gum+urea mixture was tested for viscosity on a DV-II+Brookfield viscometer with a #31 spindle at 100 rpm. The viscosity was 153 cP. The above step was repeated 4 additional times (total of 5), until the last three viscosity measurements read 460 cP, 530 cP, and 500 cP. It was then determined that 40 minutes was the point of saturation for the xanthan gum. 921.13 grams of DCD and 73.83 grams of NBPT were added along with 5.68 grams of dye to the mixture. After the dye addition, the mixture was mixed for 10 minutes. 1.66 mL of biocide was added, then mixed for an additional 5 minutes.

### Example 7—Method of Making Aqueous Suspension Composition #7

Aqueous Suspension Composition #7 contains 46.3% DCD (AB grade), 3.35% NBPT, and 0.18% xanthan gum in a 20-0-0 urea slurry with 0.17% Proxel GXL biocide. The above basic process was carried out as follows: 884.41 grams of 20-0-0 urea was added to the mixing vessel and mixed while 4.73 grams of xanthan gum was added over the course of 1 minute. After 20 minutes of mixing, the xanthan gum+urea mixture was tested for viscosity on a DV-II+Brookfield viscometer with a #31 spindle at 6 rpm. The viscosity was 575 cP. The above step was repeated 2 additional times (total of 3), until the last two viscosity measurements read 1330 cP and 1280 cP. It was then determined that 30 minutes was the point of saturation for the xanthan gum. 921.13 grams of DCD and 73.83 grams of NBPT were added along with 5.68 grams of dye to the mixture. After the dye addition, the mixture was mixed for 10 minutes. 2.82 mL of Proxel GXL biocide was then added to the mixture, and mixed for an additional 5 minutes.

### Example 8—Method of Making Aqueous Suspension Composition #8

Aqueous Suspension Composition #8 contains 48.66% DCD (AB grade), 3.90% NBPT, and 0.18% xanthan gum in a 20-0-0 urea slurry with 0.12% Proxel GXL biocide. The above basic process was carried out as follows: 886.68 grams of 20-0-0 urea was added to the mixing vessel and mixed while 3.41 grams of xanthan gum was added over the course of 1 minute. After 15 minutes of mixing, the xanthan gum+urea mixture was tested for viscosity on a DV-II+Brookfield viscometer with a #31 spindle at 100 rpm. The viscosity was 297 cP. The above step was repeated one additional time, until the final viscosity reading was 300 cP at 50 rpm. It was then determined that 25 minutes was the point of saturation for the xanthan gum. 921.13 grams of DCD and 73.83 grams of NBPT were added along with 5.68 grams of dye to the mixture. After the dye addition, the mixture was mixed for 10 minutes. 1.99 mL of Proxel GXL biocide was then added to the mixture, and mixed for an additional 5 minutes.

### Example 9—Method of Making Aqueous Suspension Composition #9

Aqueous Suspension Composition #9 contains 46% DCD (AB grade), 3.35% NBPT, and 0.25% xanthan gum in a 20-0-0 urea slurry with 0.17% Proxel GXL biocide. The above basic process was carried out as follows: 945.17 grams of 20-0-0 urea was added to the mixing vessel and mixed while 4.73 grams of xanthan gum was added over the course of 1 minute. After 20 minutes of mixing, the xanthan gum+urea mixture was tested for viscosity on a DV-II+Brookfield viscometer with a #31 spindle at 100 rpm. The viscosity was 258 cP. The above step was repeated two additional time (total of 3), until the final viscosity reading was 258 cP. It was then determined that 30 minutes was the point of saturation for the xanthan gum. 870.78 grams of DCD and 63.42 grams of NBPT were added along with 5.68 grams of dye to the mixture. After the dye addition, the mixture was mixed for 10 minutes. 2.82 mL of Proxel GXL biocide was then added to the mixture, and mixed for an additional 5 minutes.

### Example 10—Method of Making Aqueous Suspension Composition #10

Aqueous Suspension Composition #10 contains 40.55% DCD (AB grade), 3.25% NBPT, and 0.21% xanthan gum in a 20-0-0 urea slurry with 0.14% Proxel GXL biocide. The above basic process was carried out as follows: 870.78 grams of 20-0-0 urea was added to the mixing vessel and mixed while 3.98 grams of xanthan gum was added over the course of 1 minute. After 20 minutes of mixing, the xanthan gum+urea mixture was tested for viscosity on a DV-II+Brookfield viscometer with a #31 spindle at 100 rpm. The viscosity was 255 cP. The above step was repeated three additional time (total of 4), until the final viscosity reading was 258 cP. It was then determined that 35 minutes was the point of saturation for the xanthan gum. 870.78 grams of DCD and 61.52 grams of NBPT were added along with 5.68 grams of dye to the mixture. After the dye addition, the mixture was mixed for 10 minutes. 2.32 mL of Proxel GXL biocide was then added to the mixture, and mixed for an additional 5 minutes.

### Example 11—Method of Making Aqueous Suspension Composition #11

Aqueous Suspension Composition #10 contains 48.66% DCD (AB grade), 3.90% NBPT, and 0.21% xanthan gum in a 20-0-0 urea slurry with 0.14% Proxel GXL biocide. The above basic process was carried out as follows: 885.73 grams of 20-0-0 urea was added to the mixing vessel and mixed while 3.98 grams of xanthan gum was added over the course of 1 minute. After 20 minutes of mixing, the xanthan gum+urea mixture was tested for viscosity on a DV-II+Brookfield viscometer with a #31 spindle at 6 rpm. The viscosity was 2610 cP. The above step was repeated three additional time (total of 4), until the final two viscosity readings were 5570 cP and 5560 cP measured at 3 rpm. It was then determined that 40 minutes was the point of saturation for the xanthan gum. 921.13 grams of DCD and 73.83 grams of NBPT were added along with 5.68 grams of dye to the mixture. After the dye addition, the mixture was mixed for 10 minutes. 2.32 mL of Proxel GXL biocide was then added to the mixture, and mixed for an additional 5 minutes.

1. A suspension composition comprising urea, water, a suspension agent, N-(n-butyl) thiophosphoric triamide (NBPT), dicyandiamide (DCD), and an optional dye.

2. The suspension composition of claim 1, wherein the weight percentage of urea is 5-40%, the weight percentage of water is 15-40%, the weight percentage of NBPT is 0.5-20%, the weight percentage of DCD is 10-60%, the weight percentage of the suspension agent is 0.01-10%, and the weight percentage of the optional dye is 0-5%.

3. The suspension composition of claim 2, wherein the suspension agent is selected from the group consisting of dextran, gellan, rhamsan, guar, xanthan gums, tragacanth gum, hydroxymethylcellulose, hydroxyethylcellulose, microcrystalline cellulose, polyvinyl alcohols, polyvinyl acetates and cross-linked polyacrylates.

4. The suspension composition of claim 3, wherein the suspension agent is xanthan gum.

5. The suspension composition of claim 1, wherein the suspension stays substantially homogeneous for at least 30 days.

6. The suspension composition of claim 2, wherein the suspension stays substantially homogeneous for at least 30 days.

7. The suspension composition of claim 3, wherein the suspension stays substantially homogeneous for at least 30 days.

8. The suspension composition of claim 4, wherein the suspension stays substantially homogeneous for at least 30 days.

9. The suspension composition of claim 1, wherein 0.1% to 7.5% of the NBPT by weight is solubilized in the aqueous suspension.

10. The suspension composition of claim 2, wherein 0.1% to 7.5% of the NBPT by weight is solubilized in the aqueous suspension.

11. The suspension composition of claim 3, wherein 0.1% to 7.5% of the NBPT by weight is solubilized in the aqueous suspension.

12. The suspension composition of claim 4, wherein 0.1% to 7.5% of the NBPT by weight is solubilized in the aqueous suspension.

13. The suspension composition of claim 1, wherein 0.1% to 7.5% of the DCD by weight is solubilized in the aqueous suspension.

14. The suspension composition of claim 2, wherein 0.1% to 7.5% of the DCD by weight is solubilized in the aqueous suspension.

15. The suspension composition of claim 3, wherein 0.1% to 7.5% of the DCD by weight is solubilized in the aqueous suspension.

16. The suspension composition of claim 4, wherein 0.1% to 7.5% of the DCD by weight is solubilized in the aqueous suspension.

17. A method of making the suspension composition of claim 1 by blending urea, water, a suspension agent, N-(n-butyl) thiophosphoric triamide (NBPT), dicyandiamide (DCD), and the optional dye to form a homogeneous suspension.

18. A method of making a urea-containing fertilizer composition by contacting the suspension composition of claim 1 with molten urea.

19. A method of making a urea-containing fertilizer composition by contacting the suspension composition of claim 2 with molten urea.

20. A method of making a urea-containing fertilizer composition by contacting the suspension composition of claim 3 with molten urea.

21. A method of making a urea-containing fertilizer composition by contacting the suspension composition of claim 4 with molten urea.

22. The suspension composition of claim 1 further comprising a biocide.

23. The suspension composition of claim 2 further comprising a biocide.

24. The suspension composition of claim 3 further comprising a biocide.

25. The suspension composition of claim 4 further comprising a biocide.
